(19) United States
(12) Patent Application Publication
(10) Pub. No.: US 2015/0177270 A1
(43) Pub. Date: Jun. 25, 2015

(54) WEARABLE DEVICE AND CONTROL METHOD FOR WEARABLE DEVICE

(71) Applicant: Seiko Epson Corporation, Shinjuku-ku (JP)

(72) Inventors: Yuichi TAKANO, Matsumoto-shi (JP); Ryo NAKAGAWA, Chiba-shi (JP)

(21) Appl. No.: 14/579,504

(22) Filed: Dec. 22, 2014

(30) Foreign Application Priority Data
Dec. 25, 2013 (JP) 2013-266635

(51) Int. Cl. G01P 15/00

(52) U.S. Cl. CPC G01P 15/00

(57) ABSTRACT

A wearable device wearable on a human body includes a counting unit configured to count, when tap operation is performed, the number of times of taps, which is the number of times of the tap operation, a number-of-times determining unit configured to determine whether the number of times of taps counted by the counting unit reaches a predetermined number of times equal to or greater than three times and equal to or less than ten times, and an executing unit configured to execute predetermined processing when the number-of-times determining unit determines that the number of times of taps reaches the predetermined number of times.

This application claims priority to Japanese Patent Application No. 2013-266635, filed Dec. 25, 2013, the entirety of which is hereby incorporated by reference.

### BACKGROUND

1. Technical Field

The present invention relates to a wearable device wearable on a human body and a control method for the wearable device.

2. Related Art

There has been known a measuring device configured in a form of a bracelet (a wristwatch) and worn on a wrist and used. As such a measuring device, there has been known a measuring device that measures a pulse rate of a wearer (see, for example, JP-A-2006-312010 (Patent Literature 1)).

The measuring device (a sensor node) described in Patent Literature 1 includes a square case to which a band is attached, a display device, a pulse sensor, a temperature sensor, and an acceleration sensor. An emergency switch for causing the measuring device to execute processing for emergent notification to the outside is provided on the surface of the case. A measurement switch for causing the measuring device to execute processing for measuring biological information and operated when a wearer responds to an inquiry displayed by the display device is also provided on the surface of the case.

The measuring device transmits data such as temperature and a pulse sensed by the sensors to a base station through radio communication. The base station communicates with a management server present in a remote place via a wide area network such as the Internet. The management server manages the data collected from the base station using a database.

Incidentally, it is desired that a wearable device worn on a human body (e.g., a wrist) is small in size and light in weight in order to reduce a burden on a user.

However, as in the measuring device described in Patent Literature 1, if buttons (switches) for operating the measuring device are provided on the case, since the buttons project to the outer side of the case, design flexibility decreases and the measuring device tends to be increased in size. On the other hand, it is conceivable to provide a touch panel and operate the measuring device using the touch panel. However, even in such a case, it is necessary to secure an operation area of the touch panel relatively large in order to allow the wearer to easily operate the measuring device. Therefore, the measuring device tends to be increased in size.

As measures against the problem, it is conceivable to eliminate the buttons and the touch panel, provide a sensor such as an acceleration sensor for detecting tap operation of the wearer, and, when the tap operation is detected by the sensor, execute predetermine processing. This configuration attains a reduction in size of the device and improves a design property.

However, if a certain degree of large shock is applied to the measuring device, for example, when the measuring device is placed on a setting surface, the measuring device erroneously detects that the measuring device is tapped. In such a case, processing allocated to the tap operation is executed against intension of the wearer, operability is deteriorated. On the other hand, in designing the measuring device, a designer of the measuring device cannot allocate important processing to the tap operation for fear of the important processing being executed against intension of the wearer. Therefore, design flexibility is deteriorated.

Because of such problems, there has been demanded to enable the measuring device to execute predetermining processing at desired timing of the wearer.

### SUMMARY

An advantage of some aspects of the invention is to provide a wearable device and a control method for the wearable device that can surely execute predetermined processing at desired timing.

A wearable device according to a first aspect of the invention is a wearable device wearable on a human body. The wearable device includes: a counting unit configured to count, when tap operation is performed, the number of times of taps, which is the number of times of the tap operation; a number-of-times determining unit configured to determine whether the number of times of taps counted by the counting unit reaches a predetermined number of times equal to or greater than three times and equal to or less than ten times; and an executing unit configured to execute predetermined processing when the number-of-times determining unit determines that the number of times of taps reaches the predetermined number of times.

Note that examples of a part of the human body on which the wearable device is worn include a wrist and an ankle.

According to the first aspect, the predetermined processing is executed when the tap operation on the wearable device is carried out the predetermined number of times equal to or greater than three times and equal to or less than ten times. Consequently, a user of the wearable device can cause, by carrying out the tap operation the predetermined number of times, the wearable device to execute the predetermined processing.

Even when a shock similar to the tap operation is applied to the wearable device and the wearable device detects the shock as the tap operation, unless the shock is applied the predetermined number of times equal to or greater than three times and equal to or less than ten times, the predetermined processing is not executed. Therefore, since it is possible to suppress the predetermined processing from being executed by mistake, it is possible to set important processing as the predetermined processing.

Therefore, it is possible to surely execute the predetermined processing at desired timing of the user. Besides, it is possible to execute the predetermined processing without disposing a button or the like. Therefore, it is possible to attain improvement of design flexibility and a reduction in the size of the device. Further, it is possible to set important processing as processing executed by the tap operation, it is possible to improve design flexibility of the wearable device.

In the first aspect, it is preferable that the wearable device further includes: a display unit; and a display control unit configured to cause the display unit to display the number of times of taps counted by the counting unit.

Note that the display unit may be any display unit as long as the display unit can indicate the number of times of taps. For example, the display unit may be a display unit such as a liquid crystal panel or may be a display unit that indicates the number of times of taps with the number of solid-state light sources lit or extinguished among a plurality of arrayed solid-state light sources such as LEDs.

According to the first aspect with the configuration described above, the counted number of times of taps is displayed on the display unit. Therefore, it is possible to appropriately grasp the number of times of taps recognized by the wearable device. Therefore, it is possible to improve operability of the wearable device.

In the first aspect, it is preferable that the display control unit causes the display unit to hide the number of times of taps when a number-of-times display time set in advance elapses from the tap operation of the last time.

Since a battery provided in the wearable device is relatively small, a battery capacity is not large. Therefore, if the wearable device is used for a long time, it is likely that battery exhaustion is caused.

On the other hand, according to the first aspect with the configuration described above, since the number of times of taps displayed on the display unit is hidden when a number-of-times display time elapses from the tap operation of the last time, it is possible to reduce power consumption. Therefore, it is possible to suppress occurrence of battery exhaustion and use the wearable device for a relatively long time.

In the first aspect, it is preferable that, when the number-of-times determining unit determines that the number of times of taps reaches the predetermined number of times, the display control unit maintains the number of times of taps displayed on the display unit for a predetermined time.

According to the first aspect with the configuration described above, when the number of times of taps reaches the predetermined number of times, the number of times of taps is kept displayed on the display unit for the predetermined time. Consequently, the user can grasp that the wearable device recognizes the number of times of the tap operation enough for causing the wearable device to execute the predetermined processing. Therefore, it is possible to suppress unnecessary tap operation from being carried out by the user and improve operability of the wearable device.

In the first aspect, it is preferable that the wearable device further includes a number-of-times initializing unit configured to initialize, when a number-of-times retention time set in advance elapses from the tap operation of the last time, the number of times of taps counted by the counting unit.

According to the first aspect with the configuration described above, it is possible to suppress a situation in which the number of times of taps is counted because of a shock, which is not the tap operation, an accumulated number of times of taps reaches the predetermined number of times, and the predetermined processing is executed. Therefore, it is possible to improve convenience of the wearable device.

Note that, when the wearable device includes the display control unit, it is preferable that the number-of-times retention time is the same as the number-of-times display time. Consequently, since the initialization and the hiding of the number of times of taps are executed at timing when the time set in advance elapses from the tap operation of the last time, the user can more accurately grasp the number of times of taps at the present point. Therefore, it is possible to further improve the operability of the wearable device.

In the first aspect, it is preferable that the wearable device further includes a regulating unit configured to regulate, when the number-of-times determining unit determines that the number of times of taps reaches the predetermined number of times, the counting by the counting means for a regulation time set in advance.

Note that, in the regulation of the counting by the regulating unit, the regulating unit may regulate the counting by the counting unit or may regulate the detection of the tap operation by the detecting unit.

According to the first aspect with the configuration described above, when it is determined that the number of times of taps reaches the predetermined number of times, the counting by the counting unit is regulated for the regulation time. Therefore, it is possible to prevent a situation in which the tap operation by the user is repeatedly executed and the predetermined processing is repeatedly executed.

In the first aspect, it is preferable that the predetermined processing is processing for reducing power consumption of the wearable device.

As explained above, since the battery adopted in the wearable device is often a battery having relatively small size and a relatively small capacity, it is likely that battery exhaustion is caused when the battery is used for a long time.

On the other hand, according to the first aspect with the configuration described above, since the predetermined processing is the processing for reducing power consumption, it is possible to suppress occurrence of battery exhaustion and use the wearable device for a relatively long time. Therefore, it is possible to improve the convenience of the wearable device.

In the first aspect, it is preferable that the wearable device further includes: an acceleration detecting unit configured to detect an acceleration value; and an operation determining unit configured to determine on the basis of a change in the detected acceleration value whether the tap operation is performed, and the counting unit counts the number of times of taps when the operation determining unit determines that the tap operation is performed.

For example, a change in an acceleration value detected when a motion for rotating the wrist or a motion for swinging the wrist is performed when the wearable device is worn on the wrist and a change in an acceleration value detected when tap operation is performed are different from each other. Therefore, by determining presence or absence of the tap operation on the basis of a change in an acceleration value, it is possible to determine presence or absence of the tap operation relatively accurately.

When the predetermined function is executed by pressing (input) of a button, the user needs to find and press the button. When the tap operation is detected using a touch panel, the user needs to tap an arrangement position of the touch panel. Therefore, the tap operation tends to be complicated. On the other hand, according to the first aspect with the configuration described above, since presence or absence of the tap operation is determined on the basis of a change in an acceleration value, a part where the tap operation is carried out is relatively unlimited. Therefore, it is possible to make it easy to carry out the tap operation. It is possible to improve the operability of the wearable device.

A control method for a wearable device according to a second aspect of the invention is a control method for a wearable device wearable on a human body. The control method includes: counting, when tap operation is performed, the number of times of the tap operation; and executing predetermined processing when the number of times of the tap operation reaches a predetermined number of times equal to or greater than three times and equal to or less than ten times.

According to the second aspect, by applying the control method to the wearable device, it is possible to attain effects same as the effects of the wearable device according to the first aspect.

### BRIEF DESCRIPTION OF THE DRAWINGS

The invention will be described with reference to the accompanying drawings, wherein like numbers reference like elements.

FIG. 1 is a plan view showing a biological information measuring device according to an embodiment of the invention.

FIG. 2 is a perspective view showing the biological information measuring device in the embodiment.

FIG. 3 is a plan view showing a display unit in the embodiment.

FIG. 4 is a block diagram showing the configuration of the biological information measuring device in the embodiment.

FIG. 5 is a block diagram showing the configuration of a control unit in the embodiment.

FIG. 6 is a diagram showing a display state of the number of times of taps by the display unit in the embodiment.

FIG. 7 is a flowchart for explaining tap correspondence processing in the embodiment.

### DESCRIPTION OF EXEMPLARY EMBODIMENTS

### External Configuration of a Biological Information Measuring Device

An embodiment of the invention is explained below with reference to the drawings.

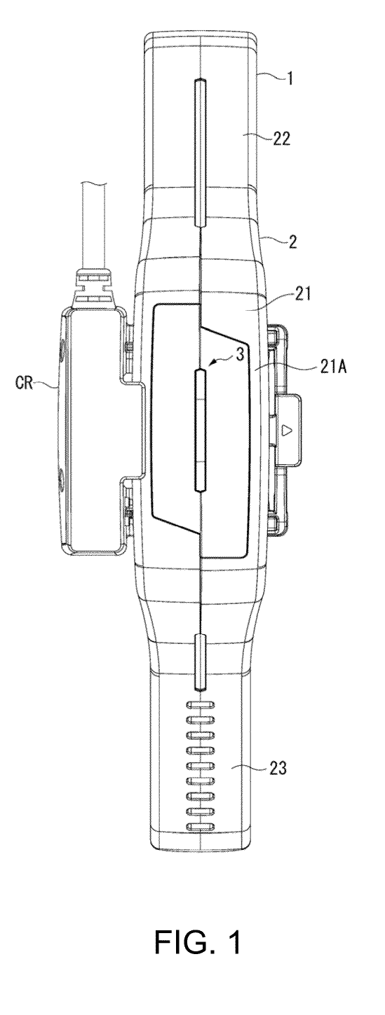

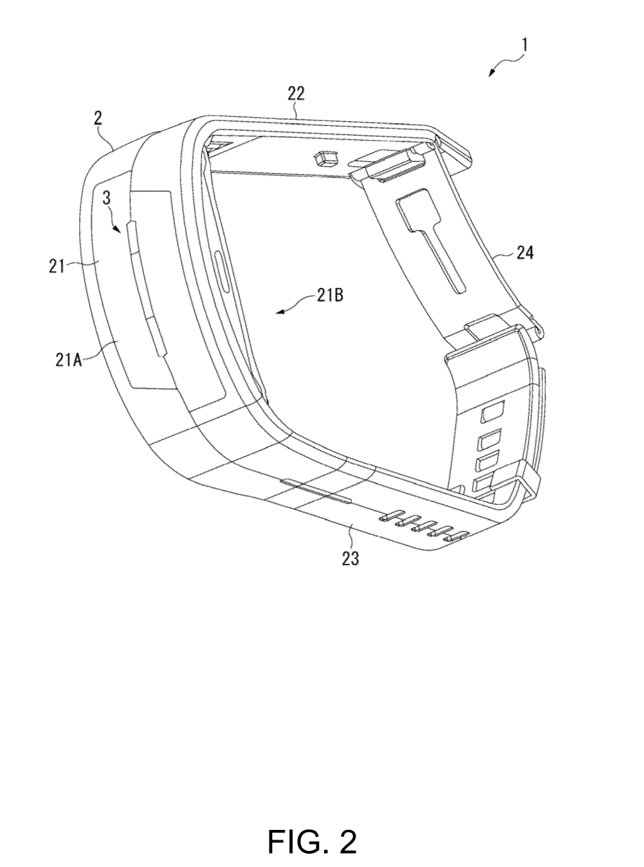

FIG. 1 is a diagram showing a state in which a biological information measuring device 1 according to this embodiment is connected to a cradle CR. FIG. 2 is a perspective view showing the biological information measuring device 1.

As shown in FIG. 1, the biological information measuring device (hereinafter sometimes abbreviated as measuring device) 1 according to this embodiment is worn on the wrist of a user after being connected to the cradle CR for power supply and charged. The measuring device 1 detects a pulse wave as biological information and measures a pulse rate. That is, the measuring device 1 is a wearable device wearable on a human body.

As shown in FIGS. 1 and 2, the measuring device 1 includes a case 2 that configures an armor. The case 2 includes a main body unit 21 and a pair of bands 22 and 23 respectively integrally configured and a buckle 24 (FIG. 2) attached to the bands 22 and 23.

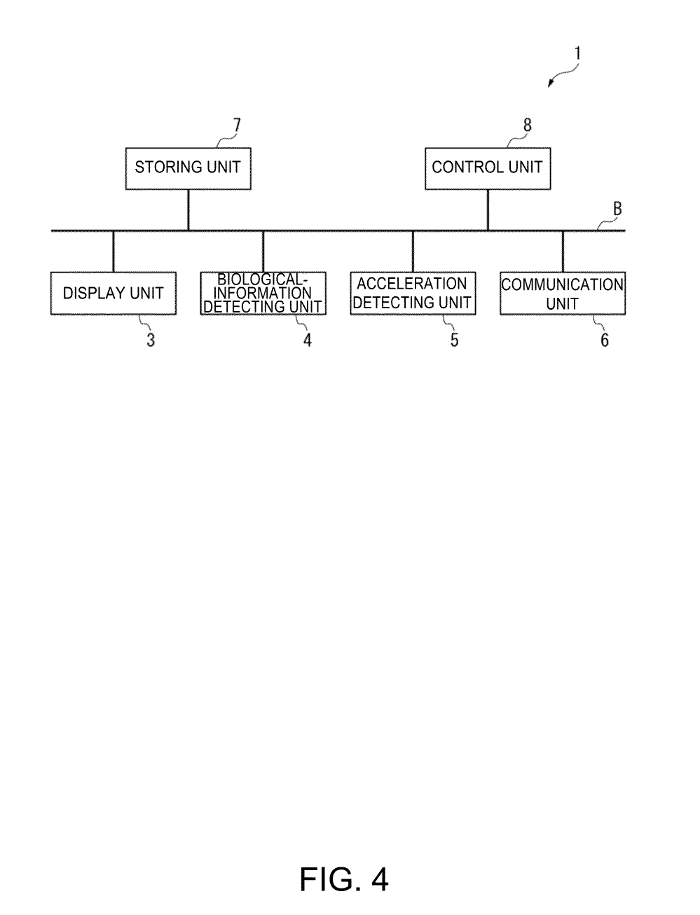

As shown in FIG. 2, the main body unit 21 is configured in a substantially arcuate shape in side view corresponding to an outer side part of the wrist (a part on the side of the back of the hand) on which the measuring device 1 is worn. In a front surface section 21A in the case 2, as shown in FIGS. 1 and 2, a display unit 3 is provided. Although not shown in FIGS. 1 and 2, a biological-information detecting unit 4 (see FIG. 4) explained below is exposed to a rear surface section 21B on the opposite side of the front surface section 21A.

The pair of bands 22 and 23 extends in opposite directions each other from one end and the other end in the longitudinal direction of the main body unit 21.

The buckle 24 is a fixing member called D buckle that fixes the bands 22 and 23 when the measuring device 1 is worn on the wrist.

In this way, it is one of objects of the measuring device 1 to attain a reduction in the size and improvement of a design property of the measuring device 1. The measuring device 1 is based on the premise that the measuring device 1 is operated by tap operation (operation for tapping the measuring device 1 with a hand, a finger, or the like) of the user. An operation unit such as a button is not provided on the case 2. However, the measuring device 1 is not limited to this. An operation unit such as buttons or a touch panel for causing the measuring device 1 to execute predetermined processing may be provided on the case 2.

### Configuration of the Display Unit

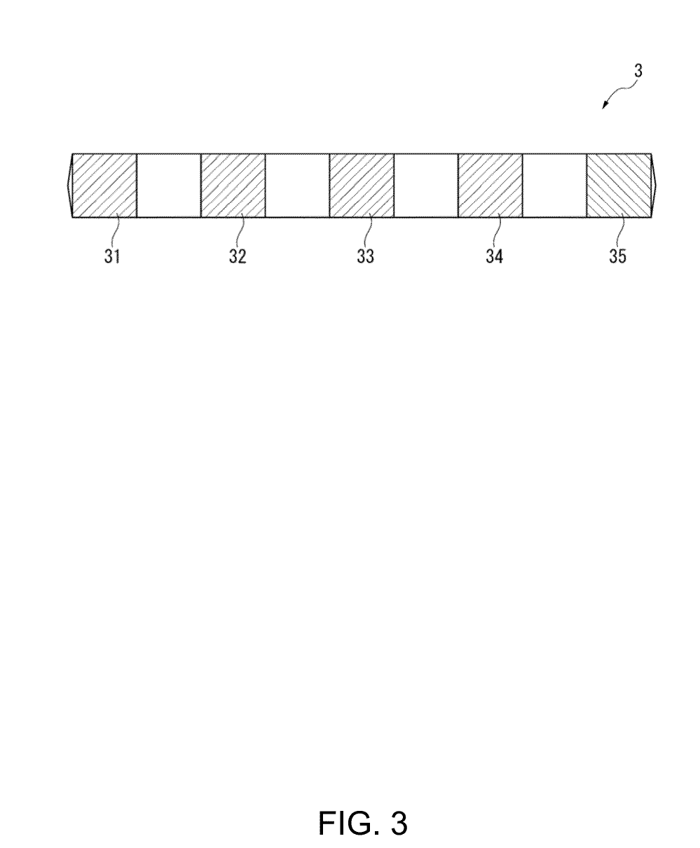

FIG. 3 is a plan view showing the display unit 3.

The display unit 3 includes, as shown in FIG. 3, five LEDs (Light Emitting Diodes) 31 to 35 arrayed along the longitudinal direction of the case 2. Under the control by a display control unit 85 explained below, the display unit 3 displays an operation state and an operating state of the measuring device 1 according to lighting (including blinking) and extinction of the LEDs 31 to 35. For example, the display unit 3 switches, every time the tap operation is performed, the LEDs from an extinguished state to a lit state one by one to display the number of times of the tap operation (hereinafter sometimes referred to as the number of times of taps). When the measuring device 1 is started (startup processing is executed), the display unit 3 sequentially switches LEDs to be lit among the LEDs 31 to 35 in order from one to another to indicate that the measuring device 1 is being started.

In this embodiment, among the LEDs 31 to 35, LEDs having different colors during light emission are respectively adopted as four LEDs 31 to 34 located on one end side (the lower side in FIG. 1) and one LED 35 located on the other end side (the upper side in FIG. 1). Specifically, LEDs that emit blue light are adopted as the LEDs 31 to 34. An LED that emits orange light is adopted as the LED 35. This makes it easy to grasp whether the number of times of the tap operation executed by the user reaches the number of times of tap operation for causing the measuring device 1 to execute a certain function. However, the LEDs 31 to 35 are not limited to this. All of the LEDs 31 to 35 may have the same color during light emission.

FIG. 4 is a block diagram showing the configuration of the measuring device 1.

The measuring device 1 includes, besides the case 2 and the display device 3, as shown in FIG. 4, a biological-information detecting unit 4, an acceleration detecting unit 5, a communication unit 6, a storing unit 7, and a control unit 8. The units 3 to 8 are electrically connected by a bus B. Besides, although not shown in the figure, the measuring device 1 includes a secondary battery that supplies electric power to the components of the measuring device 1. The secondary battery is charged by the electric power supplied from the cradle CR.

Configuration of the Biological-Information Detecting Unit

The biological-information detecting unit 4 detects biological information of a user who wears the measuring device 1. In this embodiment, the biological-information detecting unit 4 is a pulse-wave detecting unit that detects a pulse wave serving as biological information. The biological-information detecting unit 4 is exposed to a rear surface section (a part opposed to the human body) of the case 2.

The biological-information detecting unit 4 includes a photoelectric sensor including a light emitting element such as an LED and a light receiving element such as a photodiode. The photoelectric sensor causes the light emitting element to irradiate light on a living organism in a state in which the measuring device 1 is worn on the wrist. The photoelectric sensor detects a light amount change in receiving, with the light receiving element, light arriving through a blood vessel of the living organism to detect a pulse wave. The light irradiated on the living organism is partially absorbed by the blood vessel. However, an absorption ratio in the blood vessel changes according to the influence of pulsation. An amount of light reaching the light receiving element changes. An analyzing unit 92 explained below can measure a pulse rate (a pulse rate per unit time) by analyzing a temporal change, that is, a pulse wave of the light amount detected by the light receiving element.

When the measuring device 1 is detached from the wrist and changes to an unworn state, the light receiving element detects external light. The external light is extremely strong light compared with reflected light and transmitted light of the light from the light receiving element. That is, when the measuring device 1 is in the unworn state, the light amount detected by the light receiving element is extremely large compared with a light amount detected when the measuring device 1 is in the worn state. Therefore, by determining a light amount detected by the light receiving element, it is possible to determine whether the measuring device 1 is worn on the human body.

Note that, in this embodiment, the biological-information detecting unit 4 functioning as the pulse-wave detecting unit includes the photoelectric sensor. However, for example, the biological-information detecting unit 4 may include an ultrasonic sensor that detects contraction of a blood vessel with ultrasound and measures a pulse rate. The biological-information detecting unit 4 may include a sensor, a piezoelectric element, or the like that feeds a feeble current from an electrode into a body and detects a pulse.

### Configuration of the Acceleration Detecting Unit

The acceleration detecting unit 5 includes an acceleration sensor that detects an acceleration value involved in a motion of the user wearing the measuring device 1. The acceleration detecting unit 5 outputs the detected acceleration value to the control unit 8. Examples of the acceleration sensor include a three-axis sensor that detects, at a predetermined sampling frequency, acceleration values in respective axes of an X axis, a Y axis, and a Z axis.

A change in an acceleration value detected when a motion for swinging the wrist or a motion for rotating the wrist is performed by the user in a state in which the measuring device 1 is worn on the wrist and a change in an acceleration value detected when tap operation is performed on the measuring device 1 are different. Therefore, by determining the changes, it is possible to determine whether the tap operation is performed on the measuring device 1.

Note that the acceleration detecting unit 5 may include a tap operation detecting function for determining, from a detected change in an acceleration value, whether the tap operation is carried out and, when determining that the tap operation is performed, outputting an interruption signal for notifying that the tap operation is carried out to the control unit 8.

Further, the acceleration value detected by the acceleration detecting unit 5 according to the motion of the user wearing the measuring device 1 can also be used for processing for reducing the influence of the motion of the user included in the biological information detected by the biological-information detecting unit 4. That is, body motion noise included in the pulse wave detected by the biological-information detecting unit 4 may be removed using a signal from the acceleration sensor. Consequently, the acceleration detecting unit 5 can be utilized not only for detection of the tap operation but also for processing in pulse wave detection.

Configuration of the Communication Unit

The communication unit 6 is a module that communicates with an external apparatus under the control by a communication control unit 82 explained below. In this embodiment, the communication unit 6 is configured by a module that communicates with the external apparatus by radio (i.e., a module conforming to a short-range radio communication standard such as an IEEE802.15 standard. However, the communication unit 6 is not limited to this. The communication unit 6 may be a module that communicates with the external apparatus by wire. Further, the communication unit 6 may be a module capable of communicating with the external apparatus by radio and by wire.

### Configuration of the Storing Unit

The storing unit 7 has stored therein a computer program and data necessary for the operation of the measuring device 1. As the computer program, the storing unit 7 has stored therein a computer program for causing the control unit 8 to execute tap correspondence processing explained below. As the data, the storing unit 7 has stored therein connection information for performing communication connection to the external apparatus via the communication unit 6. Further, the storing unit 7 stores a detection result by the detecting units 4 and 5 under the control by the control unit 8. The storing unit 7 can be configured by a nonvolatile semiconductor memory such as a flash memory.

### Configuration of the Control Unit

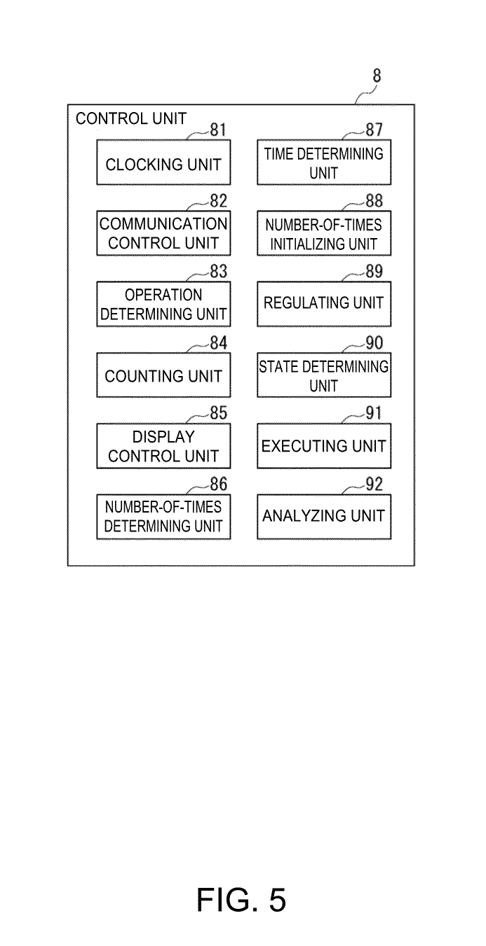

FIG. 5 is a block diagram showing the configuration of the control unit 8.

The control unit 8 is configured by a control circuit and controls the operation of the measuring device 1. That is, the control unit 8 autonomously controls the operation of the measuring device 1. Besides, the control unit 8 executes processing corresponding to operation by the user and a state of the measuring device 1 at the time when the operation is performed. For example, the measuring device 1 detects a battery voltage of the secondary battery and, when the battery voltage is equal to or less than a predetermined value, executes shutdown processing for turning off a power supply of the measuring device 1. When the tap operation is carried out on the measuring device 1 a predetermined number of times, the control unit 8 executes tap correspondence processing for executing processing corresponding to a state of the measuring device 1.

The control circuit 8 executes the computer program stored in the storing unit 7, whereby the control unit 8 includes, as shown in FIG. 5, functional units functioning as a clocking unit 81, a communication control unit 82, an operation determining unit 83, a counting unit 84, a display control unit 85, a number-of-times determining unit 86, a time determining unit 87, a number-of-times initializing unit 88, a regulating unit 89, a state determining unit 90, an executing unit 91, and an analyzing unit 92.

The clocking unit 81 clocks the present time.

The communication control unit 82 controls the communication unit 6 and communicates with the external apparatus via the communication unit 6. In the communication, the communication control unit 82 communicates with, on the basis of the connection information stored in the storing unit 7, the external apparatus to which communication connection can be established.

The operation determining unit 83 is equivalent to the operation determining unit according to the invention. The operation determining unit 83 determines on the basis of a detection result (a detected change in an acceleration value) by the acceleration detecting unit 5 whether the tap operation is performed on the measuring device 1 by the user of the measuring device 1. Note that, when the acceleration detecting unit 5 is configured to detect the tap operation and output the interruption signal when the tap operation is detected, the operation determining unit 83 determines, by determining whether the interruption signal is input, whether the tap operation is carried out.

The counting unit 84 is equivalent to the counting unit according to the invention. When the operation determining unit 83 determines that the tap operation is carried out, the counting unit 84 counts the number of times of taps and causes the storing unit 7 to store the number of times of taps. Note that, when the number of times of taps coincides with a certain condition, the number of times of taps is initialized and set to “0” by the number-of-times initializing unit 88.

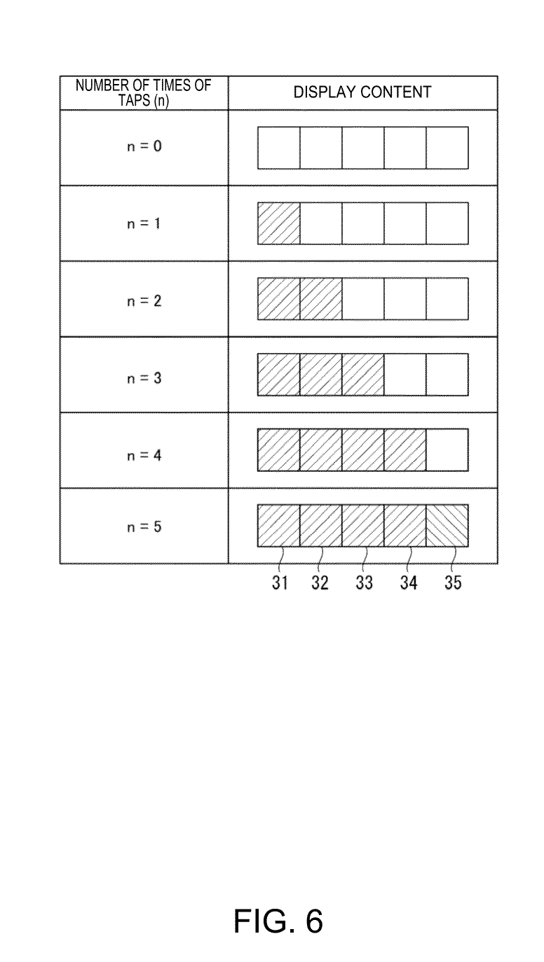

FIG. 6 is a diagram showing a display state of the number of times of taps by the display unit 3.

The display control unit 85 is equivalent to the display control unit according to the invention. The display control unit 85 controls the display unit 3. For example, as shown in FIG. 6, the display control unit 85 sequentially lights, on the basis of the number of times of taps counted by the counting unit 84, the LEDs 31 to 35 configuring the display unit 3 to thereby display the number of times of taps. For example, when the number of times of taps changes from “0” to “1”, the display control unit 85 lights only the LED 31 from a state in which all of the LEDs 31 to 35 are extinguished (a state in which the number of times of taps is “0”). When the number of times of taps changes to “2”, the display control unit 85 lights the LEDs 31 and 32 and extinguishes the LEDs 33 to 35. Thereafter, every time the number of times of taps is incremented, the display control unit 85 sequentially lights the LEDs 33 to 35.

Referring back to FIG. 5, the number-of-times determining unit 86 is equivalent to the number-of-times determining unit according to the invention. The number-of-times determining unit 86 determines whether the number of times of taps counted by the counting unit 84 reaches a predetermined number of times (N). In this embodiment, the predetermined number of times is set to “5” corresponding to the number of the LEDs 31 to 35.

The time determining unit 87 determines whether a predetermined time elapses after the operation determining unit 83 determines that the tap operation is performed. That is, the time determining unit 87 determines whether an elapsed time from the immediately preceding tap operation reaches a predetermined time (equivalent to the number-of-times display time and the number-of-times retention time; in this embodiment, three seconds). Further, the time determining unit 87 determines whether an elapsed time after the number-of-times determining unit 86 determines that the number of times of taps reaches the predetermined number of times reaches a predetermined time (equivalent to the regulation time; in this embodiment, five seconds). The predetermined times are not limited to three seconds and five seconds and can be changed.

The number-of-times initializing unit 88 is equivalent to the number-of-times initializing unit according to the invention. When the time determining unit 87 determines that the elapsed time from the immediately preceding tap operation reaches the predetermined time or determines that the elapsed time after it is determined that the number of times of taps reaches the predetermined number of times reaches the predetermined time, the number-of-times initializing unit 88 initializes the number of times of taps counted by the counting unit 84 and sets the number of times of taps to “0”. Note that, when the number-of-times initializing unit 88 sets the number of times of taps to “0”, the display of the number of times of taps by the display control unit 85 is also updated and all of the LEDs 31 to 35 are extinguished. That is, when the number-of-times determining unit 86 determines that the number of times of taps reaches the predetermined number of times, until the predetermined time elapses after the number of times of taps reaches the predetermined number of times, the number of times of taps displayed by the lighting of the LEDs 31 to 35 is maintained.

The regulating unit 89 is equivalent to the regulating unit according to the invention. When the number-of-times determining unit 86 determines that the number of times of taps reaches the predetermined number of times (five times), the regulating unit 89 regulates counting of the number of times of taps by the counting unit 84. When the time determining unit 87 determines that the elapsed time after it is determined that the number of times of taps reaches the predetermined number of times reaches the predetermined time (five seconds), the regulating unit 89 releases the regulation of the counting of the number of times of taps. That is, the regulating unit 89 regulates the counting of the number of times of taps by the counting unit 84 in a period until the predetermined time elapses after it is determined that the number of times of taps reaches the predetermined number of times (five times). The counting regulation by the regulating unit 89 in this period may be carried out by stopping the acceleration detecting unit 5 or may carries out by stopping the counting operation by the counting unit 84.

The state determining unit 90 determines the present state of the measuring device 1. Specifically, the state determining unit 90 determines, on the basis of whether power supply to a terminal (not shown in the figure) provided in the case 2 is possible, whether the measuring device 1 is connected to the cradle CR. The state determining unit 90 determines whether the present operation mode among a plurality of operation modes of the measuring device 1 is a power save mode.

Note that examples of the operation modes of the measuring device 1 include a power save mode, a detection mode, a measurement mode, and a communication mode.

The power save mode is a mode in which, although the detection of an acceleration value by the acceleration detecting unit 5 is carried out, power consumption suppression processing for regulating the detection of biological information (a pulse) by the biological-information detecting unit 4 is executed, whereby the power consumption of the measuring device 1 is reduced. The detection mode is a mode in which, for example, when the measuring device 1 is lifted from a state in which the measuring device 1 is placed on a setting table or the like, detection processing for detecting whether the measuring device 1 is capable of measuring biological information is executed. The measurement mode is a mode in which measurement processing for biological information is executed when the measuring device 1 is worn on the user and is capable of measuring biological information. The communication mode is a mode in which communication processing with the external apparatus is executed via the communication unit 6.

The executing unit 91 is equivalent to the executing unit according to the invention. When the number-of-times determining unit 86 determines that the number of times of taps reaches the predetermined number of times, the executing unit 91 executes processing corresponding to a state of the measuring device 1 determined by the state determining unit 90. For example, when the state determining unit 90 determines that the measuring device 1 is connected to the cradle CR, the executing unit 91 erases the connection information stored in the storing unit 7 and executes communication release processing for releasing the communication connection to the external apparatus. When the state determining unit 90 determines that the present operation mode of the measuring device 1 is not the power save mode, the executing unit 91 sets the operation mode of the measuring device 1 to the power save mode and executes power consumption reduction processing for, for example, stopping the biological-information detecting unit 4. When the state determining unit 90 determines that the present operation mode is the power save mode, the executing unit 91 executes startup processing (start processing) for the measuring device 1 and changes the operation mode to the detection mode.

When the present operation mode of the measuring device 1 is the measurement mode, the analyzing unit 92 analyzes a pulse wave detected by the biological-information detecting unit 4 and measures a pulse rate. The analyzing unit 92 stores the measured pulse rate in the storing unit 7 together with the present time and date clocked by the clocking unit 81.

### Tap Correspondence Processing

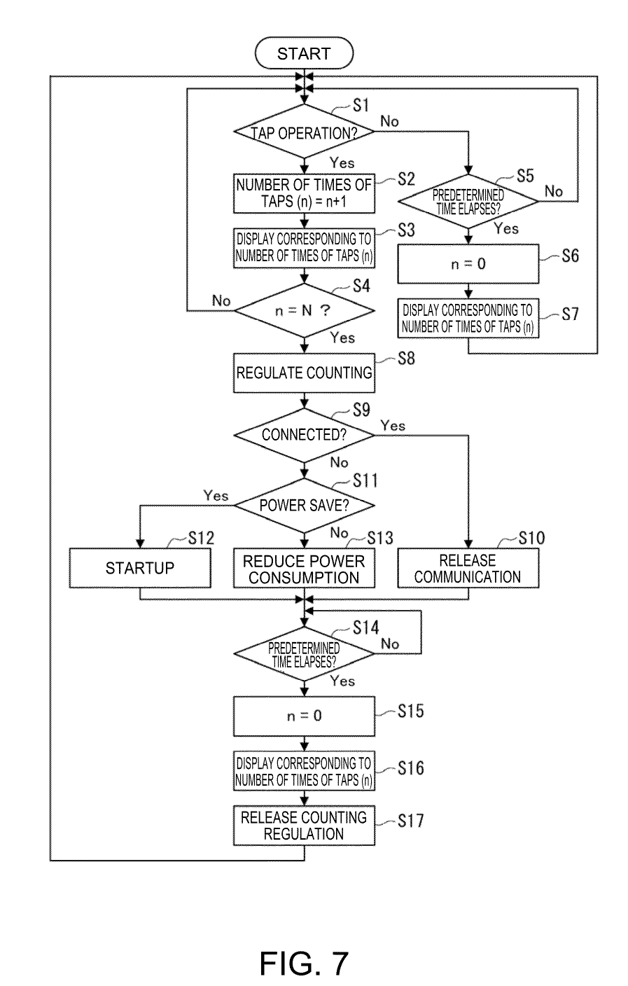

FIG. 7 is a flowchart for explaining tap correspondence processing executed by the control unit 8.

While the power supply of the measuring device 1 is on, the control unit 8 executes, on the basis of the computer program stored in the storing unit 7, tap correspondence processing explained below.

In the tap correspondence processing, as shown in FIG. 7, first, the operation determining unit 83 determines on the basis of a detection result by the acceleration detecting unit 5 whether the tap operation on the measuring device 1 is carried out (step S1).

When the operation determining unit 83 determines in the determination processing in step S1 that the tap operation is carried out, the counting unit 84 increments the number of times of taps (n) by 1 to count the number of times of taps (step S2).

After step S2, the display control unit 85 lights the LEDs 31 to 35 according to the present number of times of taps and causes the display unit 3 to display the number of times of taps (step S3).

Subsequently, the number-of-times determining unit 86 determines whether the present number of times of taps (n) reaches the predetermined number of times (N) (step S4). When the number-of-times determining unit 86 determines that the number of times of taps does not reach the predetermined number of times, the control unit 8 returns the processing to step S1.

When the operation determining unit 83 determines in the determination processing in step S1 that the tap operation is not carried out, the time determining unit 87 determines whether the predetermined time (the number-of-times display time and the number-of-times retention time; three seconds) elapses after the operation determining unit 83 determines last that the tap operation is carried out (step S5).

When the time determining unit 87 determines that the predetermined time does not elapse, the control unit 8 returns the processing to step S1.

On the other hand, when the time determining unit 87 determines that the predetermined time elapses, the number-of-times initializing unit 88 initializes the number of times of taps counted to the present to “0” (step S6). The display control unit 85 displays the initialized number of times of taps (step S7). That is, in step S6, even if the number of times of taps before the initialization is equal to or greater than “1” and equal to or less than “4”, the number of times of taps is initialized to “0”. Therefore, in step S7, all of the LEDs 31 to 34 change to the extinguished state. As shown in FIG. 6, “the number of times of taps (n)=0” is displayed. In other words, in step S7, the number of times of taps is hidden.

Thereafter, the control unit 8 shifts the processing to step S1.

When the number-of-times determining unit 86 determines in the determination processing in step S4, the regulating unit 89 regulates the counting of the number of times of taps by the counting unit 84 according to any one of the methods explained above (step S8).

Thereafter, the state determining unit 90 determines whether the measuring device 1 is connected to the cradle CR (step S9).

When the state determining unit 90 determines in the determination processing in step S9 that the measuring device 1 is connected to the cradle CR, the executing unit 91 deletes (erases) the connection information stored in the storing unit 7 and releases the communication connection to the external apparatus performed via the communication unit 6 (step S10). In step S10, the executing unit 91 releases the subsequent communication connection to the external apparatus irrespective of whether the measuring device 1 is being connected to the external apparatus rather than deleting the connection information to cut the communication connection to the external apparatus. Therefore, when the communication connection of the measuring device 1 and the external apparatus is established again, it is necessary to carry out these communication settings again.

Thereafter, the control unit 8 shifts the processing to step S14.

When determining in the determination processing in step S9 that the measuring device 1 is not connected to the cradle CR, the state determining unit 90 determines whether the present operation mode of the measuring device 1 is the power save mode (step S11).

When the state determining unit 90 determines that the present operation mode is the power save mode, the executing unit 91 releases the power save mode and executes the startup processing and shifts the measuring device 1 to a state in which the biological-information detecting unit 4 is capable of detecting biological information (a pulse wave) (step S12). Consequently, the operation mode of the measuring device 1 is changed to the detection mode in which measurement of a pulse rate is executable. Thereafter, the control unit 8 shifts the processing to step S14.

On the other hand, when the state determining unit 90 determines that the present operation mode is not the power save mode, the executing unit 91 sets the operation mode of the measuring device 1 to the power save mode and executes power consumption reduction processing for, for example, stopping the biological information detecting unit 4 (step S13). Thereafter, the control unit 8 shifts the processing to step S14.

In step S14, the time determining unit 87 determines whether time after it is determined in the determination processing in step S4 that the number of times of taps (n) reaches the predetermined number of times (N) reaches the predetermined time (the regulation time; 5 seconds) (step S14).

When the time determining unit 87 determines that the time does not reach the predetermined time, the control unit 8 repeatedly executes the determination processing in step S14.

On the other hand, when the time determining unit 87 determines that the time reaches the predetermined time, as in steps S6 and S7, the number-of-times initializing unit 88 initializes the number of times of taps counted to the present to “0” (step S15). The display control unit 85 displays, with the display unit 3, the number of times of taps after initialization (step S16). That is, according to the processing in step S16, all of the LEDs 31 to 35 are extinguished in the display of the number of times of taps. Therefore, the number of times of taps is hidden.

The regulating unit 89 releases the counting regulation set in step S8 (step S17). The control unit 8 returns the processing to step 51.

Such tap correspondence processing is repeatedly executed by the control unit 8.

In this way, until the predetermined time (five seconds) elapses after it is determined that the number of times of taps (n) reaches the predetermined number of times (N), the display of the number of times of taps (i.e., the predetermined number of times) counted by the counting unit 84 on the display unit 3 is maintained by the display control unit 85. Besides, the counting regulation by the regulating unit 89 is continued.

When the predetermined time elapses, initialization of the number of times of taps and initialization of display contents by the display unit 3 are performed. Further, the counting regulation of the number of times of taps by the regulating unit 89 is released.

### Effects of the Embodiment

Effects explained below can be attained by the measuring device 1 according to this embodiment explained above. When the tap operation on the measuring device 1 is carried out the predetermined number of times, i.e., five times, the executing unit 91 executes, according to the present state of the measuring device 1, shift processing to the power save mode (power consumption reduction processing) or release processing for the communication connection. Consequently, the user can execute the processing on the measuring device 1 with the five times of the tap operation.

Even when a chock similar to the tap operation is applied to the measuring device 1 and the measuring device 1 (the operation determining unit 83) detects the shock as the tap operation, the processing is not executed unless the shock is applied the predetermined number of times or more. Therefore, since it is possible to suppress the processing from being executed by mistake, it is possible to set important processing such as the shift processing and the release processing as the processing.

Therefore, it is possible to cause the measuring device 1 to surely execute the processing at desired timing of the user. Besides, it is possible to cause the measuring device 1 to execute the processing without arranging buttons or the like. Therefore, it is possible to attain improvement of design flexibility and a reduction in the size of the device. Further, it is possible to set important processing as processing executed by the tap operation. Therefore, it is possible to improve design flexibility of the measuring device 1.

The number of times of taps counted by the counting unit 84 is displayed on the display unit 3 by the display control unit 85. Consequently, the user can appropriately grasp the number of times of taps recognized by the measuring device 1. Therefore, it is possible to improve the operability of the measuring device 1.

When the predetermined time (the number-of-times display time and the number-of-times retention time; three seconds) elapses from the tap operation of the last time, the number of times of taps counted by the counting unit 84 is initialized. Consequently, it is possible to suppress a situation in which the number of times of taps is counted because of a shock, which is not the tap operation, an accumulated number of times of taps reaches the predetermined number of times, and the processing is executed. Therefore, it is possible to improve the convenience of the measuring device 1. Since the number of times of taps is hidden according to the initialization of the number of times of taps, the user can more accurately grasp the number of times of taps at the present point. Therefore, it is possible to further improve the operability of the wearable device. Further, since the number of times of taps is hidden, it is possible to reduce the power consumption of the display unit 3 and the measuring device 1. Therefore, it is possible to suppress occurrence of battery exhaustion and use the measuring device 1 for a relatively long time.

When the number of times of taps reaches the predetermined number of times, the number of times of taps is kept displayed on the display unit 3 for the predetermined time (five seconds). Consequently, the user can grasp that the number of times of the tap operation enough for executing the processing is recognized by the measuring device 1. Therefore, it is possible to suppress unnecessary tap operation from being carried out by the user and improve the operability of the measuring device 1.

When it is determined that the number of times of taps reaches the predetermined number of times (five times), the counting of the number of times of taps is regulated for the predetermined time (five seconds), which is the regulation time. Consequently, it is possible to prevent the tap operation by the user from being repeatedly executed and prevent the processing from being repeatedly executed. Therefore, it is possible to stabilize the operation of the measuring device 1. Besides, since unnecessary processing is prevented from being executed, it is possible to reduce the power consumption.

The processing executed when it is determined that the number of times of taps reaches the predetermined number of times (five times) includes processing for changing the operation mode of the measuring device 1 to the power save mode and reducing the power consumption of the measuring device 1. Consequently, it is possible to suppress occurrence of battery exhaustion and use the measuring device 1 for a relatively long time. Therefore, it is possible to improve convenience of the measuring device 1.

The operation determining unit 83 determines on the basis of a change in an acceleration value detected by the acceleration detecting unit 5 whether the tap operation is performed. Consequently, even when the wrist worn with the measuring device 1 is rotated or the wrist is swung, it is possible to relatively accurately detect the tap operation.

Since the presence or absence of the tap operation is determined on the basis of the detected change in the acceleration value, a part where the tap operation is carried out on the measuring device 1 is not relatively limited. Therefore, it is possible to make it easy to carry out the tap operation. It is possible to improve the operability of the measuring device 1.

### Modifications of the Embodiment

The invention is not limited to the embodiment. Modifications, improvements, and the like within a range in which the object of the invention can be attained are included in the invention.

In the embodiment, when the number of times of taps counted by the counting unit 84 reaches five times, the executing unit 91 executes the shift processing to the power save mode or the release processing for the communication connection. However, the invention is not limited to this. That is, it is sufficient that the processing is not frequently executed because of a shock, which is not the tap operation. When the counted number of times of taps reaches the number of times equal to or greater than three times set in advance, the processing only has to be executed.

It is preferable that an upper limit of the number of times of taps the predetermined processing is executed is preferably ten times. One reason for this is that, since an area of an arrangement part of a display unit is limited in a wearable device, if the upper limit of the number of times of taps for executing the predetermined processing exceeds ten times, it is difficult to grasp whether the number of times of taps to be displayed (a counted number of times of taps) is enough for executing the processing.

Specifically, in the measuring device 1, the number of LEDs configuring the display unit 3 and indicating the number of times of taps by being lit and extinguished is set to five. It is possible to display the number of times of taps of maximum ten times by reciprocatingly lighting the five LEDs 31 to 35 arrayed along the longitudinal direction of the front surface section 21A. However, if it is attempted to display the number of times of taps equal to or greater than eleven times, it is necessary to perform the reciprocating lighting twice or more. The user less easily grasps the number of times of taps. On the other hand, it is conceivable to increase the arrangement part and increase the display unit in size (increase the number of LEDs). However, in this case, the wearable device is increased in size. Therefore, when a balance between a reduction in the size of the wearable device and easiness in grasping the displayed number of times of taps is taken into account, the upper limit of the number of times of taps for executing the predetermined processing is preferably ten times.

Note that the processing to be executed may be varied according to the number of times of taps. For example, when the number of times of continuous taps reaches five times, the shift processing to the power save mode or the release processing for the communication connection is executed according to a state of the measuring device 1. When the number of times of continuous taps reaches ten times, system reset may be executed.

Further, the processing executed by the executing unit 91 is not limited to the shift processing to the power save mode and the release processing for the communication connection. Examples of the processing include processing for starting and stopping measurement of biological information, reset processing of data stored in the storing unit 7, processing for starting and stopping communication with the external apparatus, processing for lighting a backlight when the display unit 3 includes a display device such as a liquid crystal panel, ON/OFF processing of a vibrator function or an alarm function, and event recording processing.

The event recording processing is processing for acquiring, from the present time clocked by the clocking unit 81, time when the number of times of taps reaches the predetermined number of times and causing the storing unit 7 to store the time as time when some event occurs (event occurrence time).

It is possible to determine on the basis of the intensity of light detected by the biological-information detecting unit 4 whether the measuring device 1 is worn on the user. Therefore, processing to be executed may be changed according to whether the measuring device 1 is worn.

Further, as explained above, the predetermined time equivalent to the number-of-times display time and the number-of-times retention time is not limited to three seconds and can be changed. The predetermined time equivalent to the regulation time is not limited to five seconds and can be changed.

In this embodiment, the counted number of times of taps is displayed on the display unit 3. However, the invention is not limited to this. That is, the number of times of taps does not have to be displayed. The display device 3 may be absent. Even when the measuring device 1 includes the display unit 3, the measuring device 1 may be configured to display the number of times of taps as a number with a display device such as a liquid crystal panel rather than displaying the number of times of taps with the plurality of LEDs 31 to 35. Further, the LEDs 31 to 35, which indicates the number of times of taps, are not limited to be arranged in the front surface section 21A and may be arranged in, for example, the bands 22 and 23.

In the embodiment, when the predetermined time (three seconds) elapses from the tap operation of the last time, the number of times of taps is initialized and hidden. However, the invention is not limited to this. For example, the initialization and the hiding of the number of times of taps may be executed according to, for example, operation by the user.

In the embodiment, when the counted number of times of taps reaches the predetermined number of times, the displayed number of times of taps is maintained and the counting of the number of times of taps is regulated for the predetermined time (five seconds). However, the invention is not limited to this. For example, the display control unit 85 may cause the display unit 3 to display content indicating that the processing performed when the number of times of taps reaches the predetermined number of times is being executed. It is also possible that the regulation of the number of times of taps by the counting unit 84 is not carried out and the executing unit 91 does not execute redundant processing.

In the embodiment, the operation determining unit 83 determines on the basis of the change in the acceleration value detected by the acceleration detecting unit 5 whether the tap operation is performed. However, the invention is not limited to this. That is, the operation determining unit 83 may determine, according to other parameters, whether the tap operation is performed. Further, the user may execute set processing by performing a plurality of times, rather than the tap operation, an operation capable of detecting a characteristic acceleration change.

In the embodiment, the measuring device 1 functioning as the wearable device detects a pulse wave of the user as biological information and analyzes the pulse wave to measure a pulse rate. However, the invention is not limited to this. That is, the measuring device 1 may be configured as a measuring device that measures other kinds of biological information such as a body temperature, a blood pressure, an electrocardiogram, and a brain wave.

In the embodiment, the operation determining unit 83 functioning as the operation determining unit according to the invention, the counting unit 84 functioning as the counting unit according to the invention, the number-of-times determining unit 86 functioning as the number-of-times determining unit according to the invention, and the executing unit 91 functioning as the executing unit according to the invention are realized by the control circuit processing the computer program stored in the storing unit 7. That is, the operation determining unit, the counting unit, the number-of-times determining unit, and the executing unit are integrally configured by one control circuit. However, the invention is not limited to this. That is, at least two of the operation determining unit, the counting unit, the number-of-times determining unit, and the executing unit may be integrally configured. Even with such a configuration, it is possible to simplify the configuration of the wearable device. Manufacturing of the wearable device is facilitated. On the other hand, the operation determining unit, the counting unit, the number-of-times determining unit, and the executing unit may be separately configured.

The measuring device 1 that measures biological information is explained as an example of the wearable device. However, the invention is not limited to this. That is, the invention can be applied to any wearable device worn on the human body. The invention may be applied to, for example, a wristwatch, an activity monitor, a kinematic analysis device, a motion analysis device, a head mounted display, and a posture detecting device. Further, a part of the human body on which the wearable device is mounted is not limited to the wrist and may be other parts such as an ankle.

What is claimed is:

1. A wearable device wearable on a human body, the wearable device comprising:
a counting unit configured to count, when tap operation is performed, a number of times of taps, which is a number of times of the tap operation;
a number-of-times determining unit configured to determine whether the number of times of taps counted by the counting unit reaches a predetermined number of times equal to or greater than three times and equal to or less than ten times; and
an executing unit configured to execute predetermined processing when the number-of-times determining unit determines that the number of times of taps reaches the predetermined number of times.

2. The wearable device according to claim 1, further comprising:
a display unit; and
a display control unit configured to cause the display unit to display the number of times of taps counted by the counting unit.

3. The wearable device according to claim 2, wherein the display control unit causes the display unit to hide the number of times of taps when a number-of-times display time set in advance elapses from the tap operation of a last time.

4. The wearable device according to claim 2, wherein, when the number-of-times determining unit determines that the number of times of taps reaches the predetermined number of times, the display control unit maintains the number of times of taps displayed on the display unit for a predetermined time.

5. The wearable device according to claim 1, further comprising a number-of-times initializing unit configured to initialize, when a number-of-times retention time set in advance elapses from the tap operation of a last time, the number of times of taps counted by the counting unit.

6. The wearable device according to claim 1, further comprising a regulating unit configured to regulate, when the number-of-times determining unit determines that the number of times of taps reaches the predetermined number of times, the counting by the counting means for a regulation time set in advance.

7. The wearable device according to claim 1, wherein the predetermined processing is processing for reducing power consumption of the wearable device.

8. The wearable device according to claim 1, further comprising:
an acceleration detecting unit configured to detect an acceleration value; and
an operation determining unit configured to determine on the basis of a change in the detected acceleration value whether the tap operation is performed,
wherein
the counting unit counts the number of times of taps when the operation determining unit determines that the tap operation is performed.

9. A control method for a wearable device wearable on a human body, the control method comprising:
counting, when tap operation is performed, a number of times of the tap operation; and
executing predetermined processing when the number of times of the tap operation reaches a predetermined number of times equal to or greater than three times and equal to or less than ten times.
